(19) United States
(12) Patent Application Publication
(10) Pub. No.: US 2011/0044591 A1
(43) Pub. Date: Feb. 24, 2011

(54) OPTICAL TRANSCEIVER WITH OPTICAL RECEPTACLE SEPARATED FROM FRAME AND PROCESS TO ASSEMBLE THE SAME

(75) Inventors: Satoshi YOSHIKAWA, Yokohama-shi (JP); Yuuichi KITAJIMA, Yokohama-shi (JP)

Correspondence Address: VENABLE LLP, P.O. BOX 34385, WASHINGTON, DC, 20043-9998, US

(73) Assignee: SUMITOMO ELECTRIC DEVICE INNOVATIONS, INC., Yokohama-shi (JP)

(21) Appl. No.: 12/858,947

(22) Filed: Aug. 18, 2010

(30) Foreign Application Priority Data
Aug. 19, 2009 (JP) 2009-190355

(51) Int. Cl. G02B 6/36

(52) U.S. Cl. 385/88

(57) ABSTRACT

An optical transceiver with an optical receptacle separated from the frame is disclosed. The optical transceiver comprises an optical sub-assembly, an optical receptacle and a frame. The optical receptacle, which is set between the side walls of the frame, and assembled therewith by fastening a screw between the optical receptacle and the side wall of the frame. Inserting the screw into the screw hole, the optical receptacle is forced to move rearward which securely fixes the optical subassembly assembled with the optical receptacle between the optical receptacle and the saddle provided in the frame.

### CROSS REFERENCE TO RELATED APPLICATION

The present application is closely related to the following commonly-assigned U.S. Patent Applications: U.S. Ser. No. 10/777,766, entitled: OPTICAL TRANSCEIVER HAVING AN OPTICAL RECEPTACLE OPTIONALLY FIXED TO A FRAME, now issued as U.S. Pat. No. 7,350,979, which is incorporated herein reference in its entirety.

### BACKGROUND OF THE INVENTION

1. Field of the Invention

The present invention relates to an optical transceiver that provides an optical receptacle separated from the frame, and the invention relates to a process to manufacture the optical transceiver.

2. Related Prior Art

An optical transceiver generally comprises an optical sub-assembly installing a semiconductor optical device therein, an optical receptacle that receives an external optical connector securing an optical fiber therein, and a frame that constitutes a housing of the optical transceiver. The process to assemble such an optical transceiver has been disclosed in U.S. Pat. No. 7,350,979 in which the optical subassembly is assembled with the optical receptacle first, and then the optical receptacle with the optical subassembly is set on the frame between the side walls, and finally, a screw is fastened between the side wall of the frame and the side of the optical receptacle. An insertion length of the screw may determine a position of the optical receptacle and the optical subassembly relative to the frame.

### SUMMARY OF THE INVENTION

One aspect of the present invention relates to an optical transceiver that optically couples with an optical connector securing an optical fiber therein. The optical transceiver of the present invention may include an optical subassembly that installs a semiconductor optical device to be coupled with the optical fiber; a frame that mounts the optical subassembly and has a pair of said walls each provided a portion of a screw hole; an optical receptacle, which is separated from the frame and set between the side walls of the frame that receives the optical connector and has a pair of sides each providing another portion of the screw hole; and a screw fastened in the screw hole. A feature of the optical transceiver according to the present embodiment is that the screw fastened in the screw hole presses the optical receptacle rearward with respect to the frame, which may fix the optical subassembly securely between the optical receptacle and the frame.

Another aspect of the present invention relates to a process to assembly the optical transceiver. The process may comprise steps of: (a) assembling the optical subassembly with the optical receptacle; (b) setting the optical receptacle assembled with the optical subassembly between the side walls of the frame such that the bottom of the optical receptacle comes in contact with the bottom of the frame; and (c) fastening a screw in a screw hole constituted of a first portion in the side wall of the frame and a second portion in a side of the optical receptacle such that the optical receptacle is forced to push back rearward. A feature of the process of the invention is that the optical receptacle abuts the optical subassembly against the frame to fix a position of the optical subassembly along the longitudinal direction of the optical transceiver.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a perspective view of the optical transceiver according to an embodiment of the present invention;

FIG. 2 is an exploded view of the optical transceiver shown in FIG. 1;

FIGS. 3A and 3B are perspective views of the optical receptacle implemented in the optical transceiver shown in FIG. 1, where FIG. 3A views the optical receptacle from the front bottom, while FIG. 3B views the optical receptacle from the rear bottom;

FIG. 4 is plan view that magnifies a front portion of the optical transceiver shown in FIG. 1;

FIG. 5 is a cross section of the front portion taken along the ling V-V shown in FIG. 4;

FIG. 6A schematically illustrates an arrangement of the screw hole before a screw is fastened therein, and FIG. 6B illustrates the screw hole when the screw is fastened therein;

FIG. 7 is an exploded view of an optical transceiver according to another embodiment of the present invention;

FIG. 8 is a perspective view of the optical transceiver shown in FIG. 7;

FIG. 9 is a plan view that magnifies a front portion of the optical transceiver shown in FIG. 7; and

FIG. 10A schematically illustrates an arrangement of the screw before a screw is fastened, and FIG. 10B corresponds to an arrangement after the screw is fastened within the screw hole.

### DETAILED DESCRIPTION OF PREFERRED EMBODIMENTS

Next, preferred embodiments according to the present invention will be described as referring to accompanying drawings. In the description of the drawings, the same element will be referred by the same numeral or the same symbol without overlapping explanations.

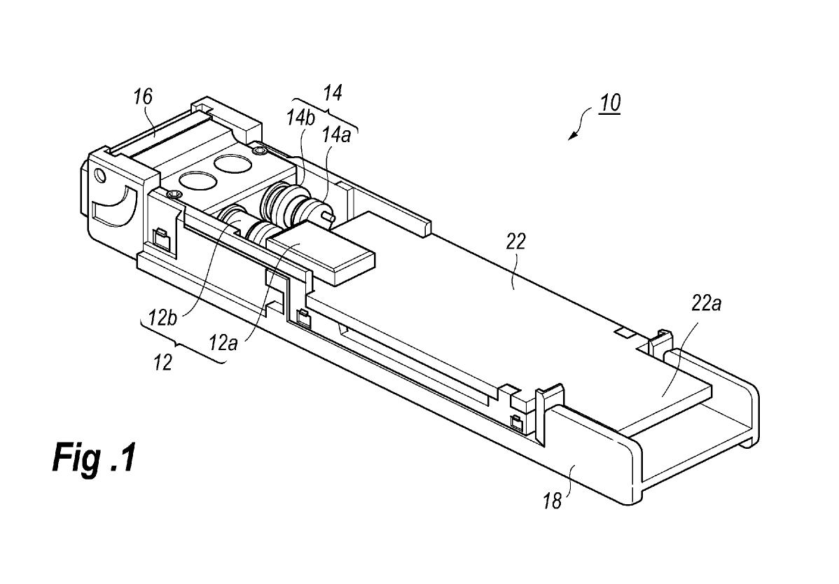

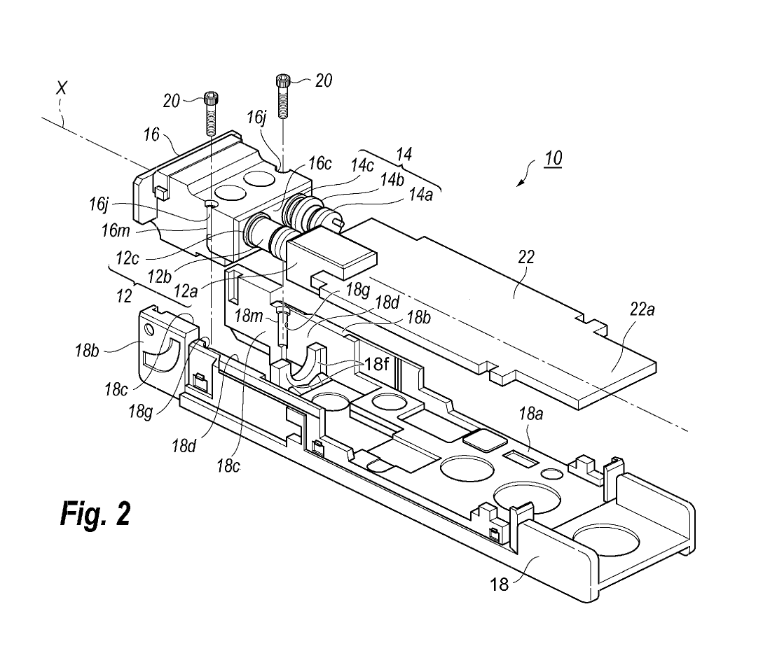

FIG. 1 is a perspective view of an optical transceiver according to an embodiment of the present invention; while, FIG. 2 is an exploded view of the optical transceiver shown in FIG. 1. As illustrated in FIGS. 1 and 2, the optical transceiver 10 of the embodiment comprises optical sub-assemblies, a transmitter optical sub-assembly (TOSA) 12 and a receiver optical sub-assembly (ROSA) 14, an optical receptacle 16, a frame 18, screws 20 and a circuit board 22. In the description presented below assumes a direction to which the TOSA 12 emits light, that is, the side where the optical receptacle 16 is implemented, as the forward and the other direction where the TOSA 12 locate with respect to the optical receptacle 16 as the rear. The description below further assumes a direction within the surface of the circuit board 22, which is perpendicular to the longitudinal axis X of the optical transceiver 10, as the side and a direction along which the screws 20 are inserted as the down.

The TOSA 12, which transmits light, includes a package portion 12a and a sleeve portion 12b. The package portion 12a that has a rectangular shape in the present embodiment installs a semiconductor light-emitting device, typically a semiconductor laser diode (LD), therein. The sleeve portion 12b that has a cylindrical shape extends along the longitudinal axis X from the package portion 12a. The sleeve portion 12b receives a ferrule attached in an end of an optical connector inserted into the optical receptacle 16 to couple the LD in the package portion 12a optically with an optical fiber secured in the ferrule.

The ROSA 14, which receives light, includes a package portion 14a and a sleeve portion 14b. The package portion 14a that has a cylindrical shape in the present embodiment installs a semiconductor light-receiving device, typically a semiconductor photodiode (PD), therein. The sleeve portion 14b that has a cylindrical shape extends along the longitudinal axis X from the package portion 14a. The sleeve portion 14b receives another ferrule attached in an end of the optical connector to couple the PD in the package portion 14a optically with the other optical fiber secured in the optical connector. Thus, the optical transceiver 10 enables the optical communication with the full duplex configuration.

The TOSA 12 and the ROSA 14, which are arranged in the front of the circuit board, electrically couples therewith by respective flexible printed circuit boards, not shown in FIGS. 1 and 2. The rear of the circuit board 22 provides an electrical plug 22a to be mated with an electrical connector implemented in the host system. Thus, the optical transceiver 10 may electrically communicate with the host system.

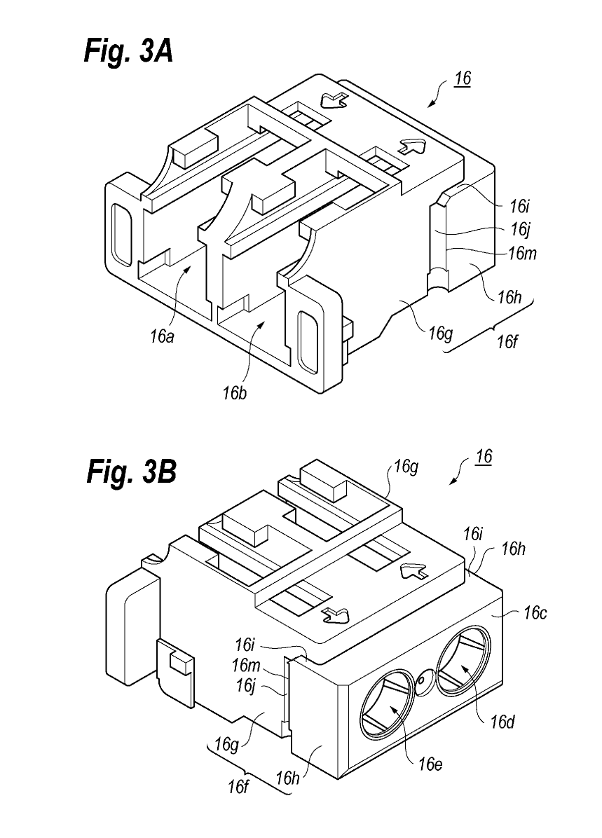

As described above, the TOSA 12 and the ROSA 14 are assembled with the optical receptacle 16 so as to insert respective sleeve portions, 12b and 14b, into the optical receptacle 16. FIGS. 3A and 3B are a perspective view of the optical receptacle 16; where FIG. 3A views the optical receptacle 16 from the front but the optical receptacle 16 is set in upside-down, while, FIG. 3B views the optical receptacle 16b from the rear.

The optical receptacle 16 provides two cavities, 16a and 16b; where the former cavity 16a mates the TOSA 12 with the optical connector therein, while, the latter cavity 16b mates the ROSA 14 with the optical connector therein. The optical receptacle 16 further includes a wall 16c, which is substantially perpendicular to the longitudinal axis X, including two openings, 16d and 16e. The opening 16d links with the cavity 16a; while, the other opening 16e links with the other cavity 16b. As shown in FIGS. 1 and 2, the first opening 16d receives the sleeve portion 12b of the TOSA 12, and the other opening 16e receives the sleeve portion 14b of the ROSA 15.

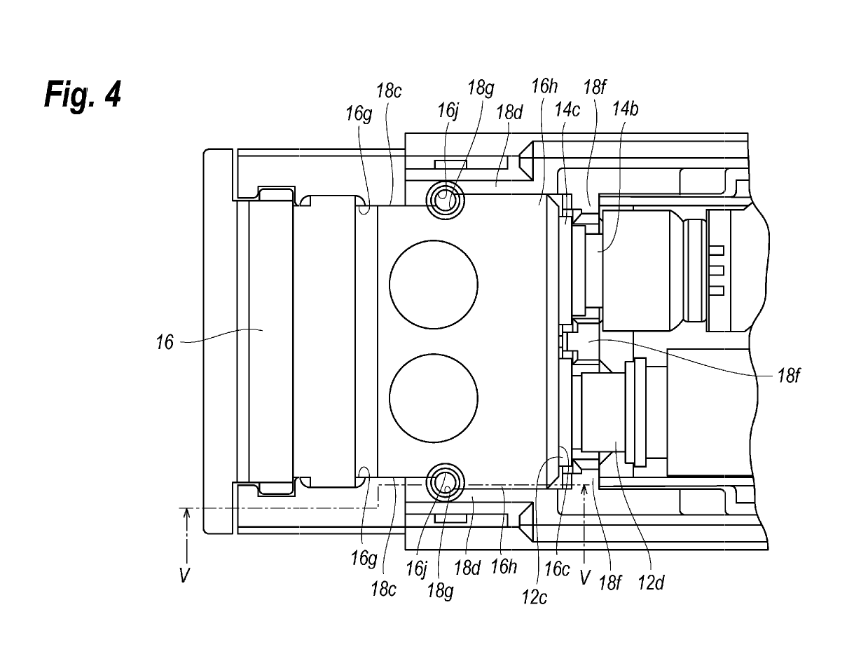

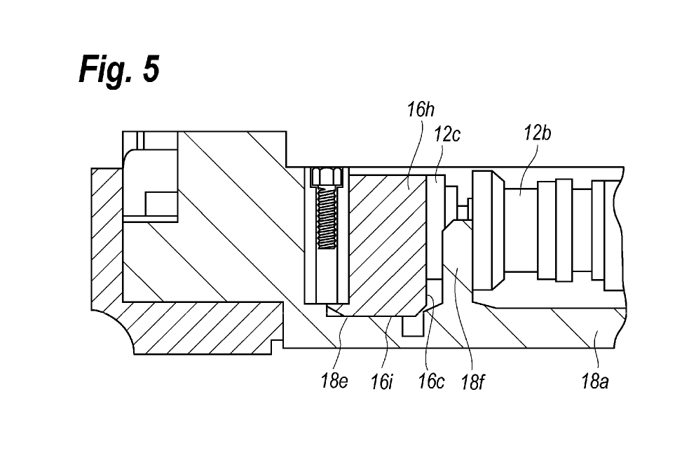

FIG. 4 is a plan view of the front of the optical transceiver 10, and FIG. 5 is a cross section taken along the ling V-V in FIG. 4. As shown in FIGS. 4 and 5, the sleeve portion 12b of the TOSA 12 includes a flange 12c extending in perpendicular the axis X. The sleeve portion 12b is inserted into the opening 16d until the front surface of the flange 12c comes in contact with the rear wall 16c of the optical receptacle 16. Similarly, the sleeve portion 14b of the ROSA 14 includes a flange 14c whose front surface comes in contact with the rear wall 16c when the sleeve portion 14b is inserted into the other opening 16e. Thus, the TOSA 12 and the ROSA 14 may be defined in positions thereof with respect to the optical receptacle 16.

Referring to FIGS. 1 and 2 again, the frame 18 includes a bottom frame 18a and a pair of side walls 18b. The bottom frame 18a extends along the longitudinal axis X and the circuit board 22 is arranged in the optical transceiver 10 so as to make substantially in parallel to the bottom frame 18a. The TOSA 12 in the package portion 12a thereof is arranged on the bottom frame 18a through a thermal sheet, typically made of silicone resin, to make heat generated in the package portion 12a dissipating effectively to the frame 18.

The side wall 18b also extends along the axis X but rises so as to cross the bottom frame 18a in both sides thereof. The end of the side wall 18b protrudes forward from the front end of the bottom frame 18a to provide a space where the optical receptacle 16 is set therein. The optical receptacle 16, as illustrated in FIG. 3, provides a side 16f facing the side wall 18b. The side 16f of the optical receptacle 16 includes surfaces, 16g and 16h, between which is formed with a slope 16m where a portion of a screw hole 16j is formed. A detail of the screw hole 16j will be described later. The latter surface 16h is arranged in the rear compared to the other surface 16g and projected therefrom so as to form a terrace.

As illustrated in FIGS. 2 and 4, the side wall 18b in the front side thereof provides two inner surfaces, 18c and 18d, between which is formed with a slope 18m where a portion of a screw hole 18g is formed. The former surface 18c faces the surface 16g of the optical receptacle 16, while, the latter surface 18d is arranged in the rear of the former surface 18c and is depressed with respect to the former 18c.

The surface 18d may guide the terrace 16h when the optical receptacle 16 is set between the side walls 18b. As illustrated in FIGS. 3 and 5, the optical receptacle 16 provides a bottom 16i in a rear thereof. That is, the terrace 16h continues the rear surface 16c so as to form the bottom 16i. On the other hand, the frame 18 provides a front bottom 18e facing the bottom 16i of the optical receptacle 16. The second side surface 18d of the side wall 18 rises from this front bottom 18e. Setting the optical receptacle 16 between the side walls 18b, the bottom 16i comes in contact with the front bottom 18e to fix the position of the optical receptacle 16 with respect to the frame 18.

The optical receptacle 16 may narrower the width in the terrace 16h as closing the bottom thereof, and the second inner surface 18d of the frame 18 may form a slight gap against the terrace 16h, which may facilitate the set of the optical receptacle 16 in the frame 18.

As illustrated in FIGS. 2, 4 and 5, the frame 18 provides a saddle 18f in the front bottom 18e thereof. The saddle 18f may set the sleeve portion, 12b and 14b, thereon. The front of the saddle 18f comes in contact with the rear surface of the flange, 12c and 14c. Thus, the flange, 12c and 14c, is set between the rear surface 16c of the optical receptacle 16 and the front surface of the saddle 18f to define the position of the TOSA 12 and the ROSA 14 along the longitudinal axis X.

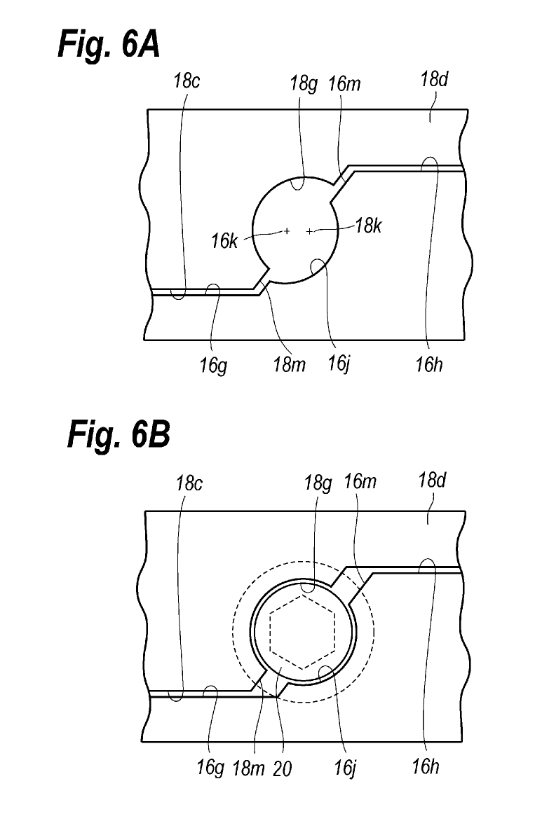

As already mentioned, between the side surfaces, 16g and 16h, of the optical receptacle 16 is formed with a slope 16m where a portion of the screw hole 16j is formed as shown in FIGS. 2 to 4; while, between the inner surfaces, 18c and 18d, of the side wall 18b is formed with the other slope 18m where the other portion of the screw hole 18g is formed. A screw hole combined with two portions, 16j and 18j, expands along the longitudinal direction as the screw 20 is fastened in the screw hole. FIGS. 6A and 6B schematically illustrate an arrangement of thus combined screw hole, where FIG. 6A corresponds to a state before the screw is fastened therein, while, FIG. 6B shows a state where a screw is fastened. As illustrated in FIG. 6A, the center 16k of the screw hole 16j offsets forward to the center 18k of the other screw hole 18g.

Fastening the screw 20 in the screw hole, the center 16k of the screw hole 16j moves rearward, as illustrated in FIG. 6B, which makes the position of the optical receptacle 16 rear to come the rear surface of the flange, 12c and 14c, in securely contact with the front surface of the saddle 18f. Accordingly, the TOSA 12 and the ROSA 14 may be securely positioned along the longitudinal axis X. Moreover, fastening the screw 20 in the screw hole may make the bottom 16i of the optical receptacle 16 in contact with the bottom frame 18e. Thus, the TOSA 12 and the ROSA 14 may be positioned relative to the optical receptacle 16 and to the frame 18 only by fastening the screw 20 in the screw hole independent of an inserting depth of the screw hole 20.

One of the portion of the screw holes, 16j or 18g, may provide threads before the screw is fastened. The screw 20 as it is fastened in the screw hole may form the treads in the portion of the screw hole where no threads are provided in advance. Thus, the optical receptacle 16 may be fastened with the frame 18 as being pushed rearward.

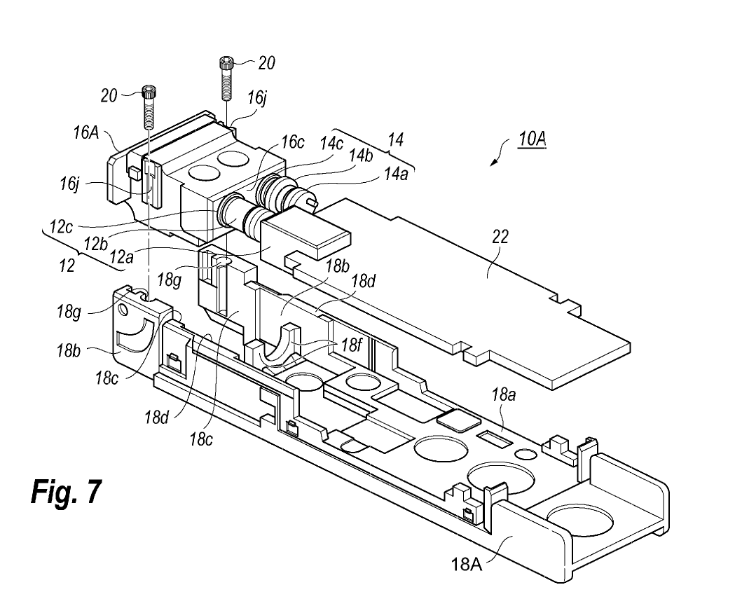

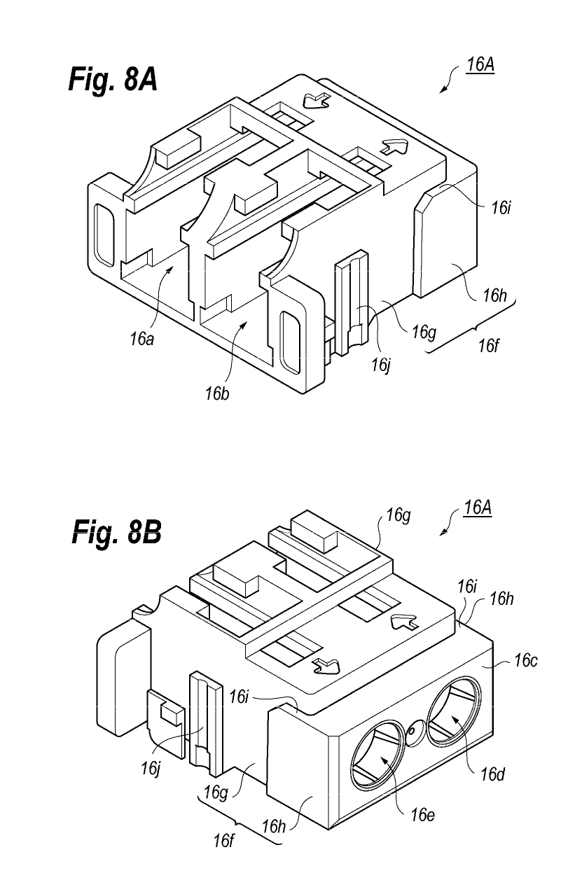

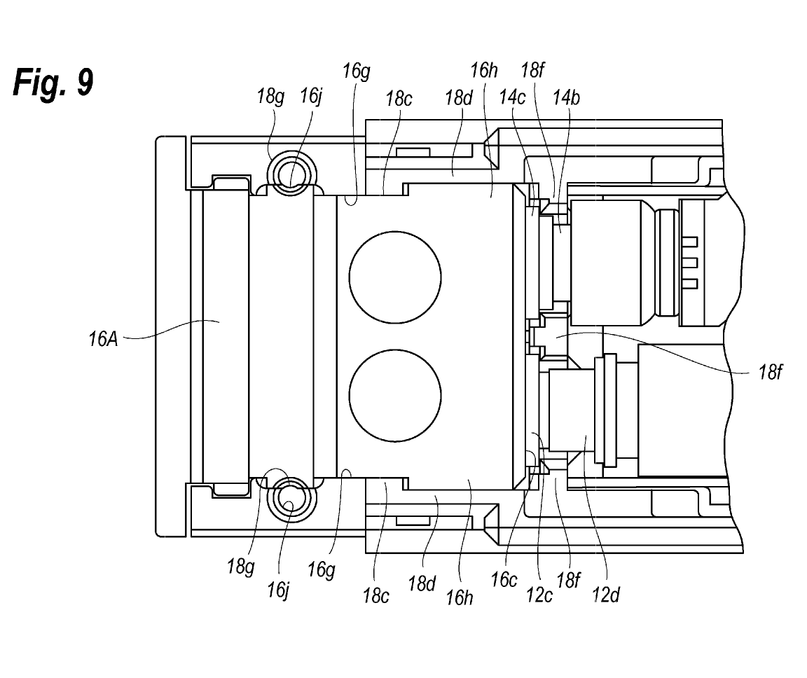

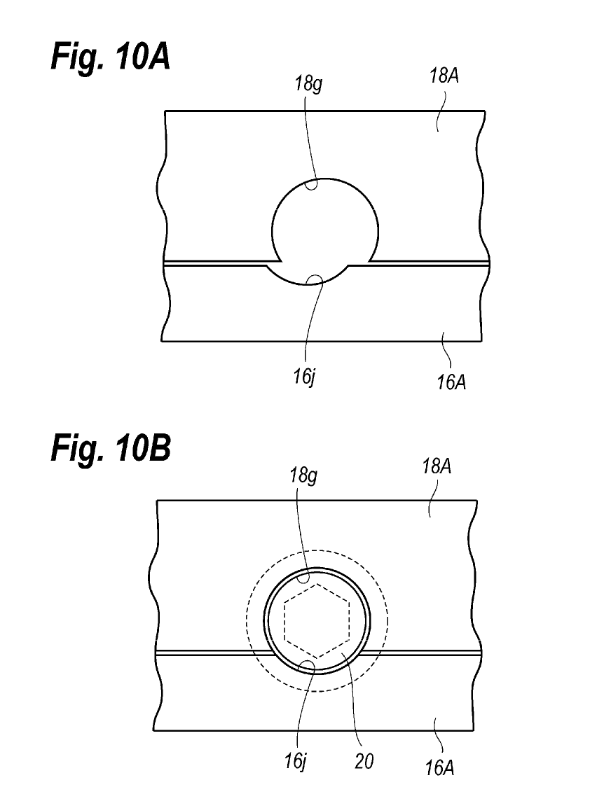

Next, another embodiment of the optical transceiver according to the present invention will be described. FIG. 7 is an exploded view of another optical transceiver 10A according to an embodiment of the invention; FIG. 8 is a perspective view of the optical receptacle 16A implemented in the optical transceiver 10A shown in FIG. 7; FIG. 9 is a plan view that magnifies a front portion of the optical transceiver 10A shown in FIG. 7; and FIG. 10 schematically shows a screw hole according to the present embodiment.

The optical transceiver 10A has a feature that the position of the screw hole is different from the position of afore mentioned optical transceiver 10. Other arrangements are same with or similar to those appeared in the former optical transceiver 10.

As illustrated in FIGS. 7 to 9, a portion 16j of the screw hole is formed forward to the terrace 16h in the side 16f of optical receptacle 16, which is comparable to the position of the screw hole in the first embodiment. Also, the portion of the screw hole 18g is formed forward to the second surface 18d in the inner surface of the side wall 18b.

As shown in FIG. 10A, the center of the hole 16j is positioned forward to the other center of the hole 18g before the screw is set in the hole. Accordingly, fastening the screw 20 in the hole, the optical receptacle 16 may be forced to move rearward, which may cause the rear surface of the flange, 12c and 14c, coming in securely contact with the front surface of the saddle 18g; thus, the TOSA 12 and the ROSA 14 may be positioned along the longitudinal axis X, and may cause the bottom 16i in the optical receptacle coming in securely contact with the front bottom 18e of the frame 18.

Next, a process to manufacture the optical transceiver 10 will be described. First, the TOSA 12 and the ROSA 14 are assembled with the optical receptacle 16. Specifically, the sleeve portion, 12b and 14b, is inserted into the corresponding openings, 16d and 16e, which is provided in the rear surface 16c of the optical receptacle 16, until the front surface of the flange, 12c and 14c, comes in contact with rear surface 16c.

The process next sets the optical receptacle 16 assembled with the TOSA 12 and the ROSA 14 between the side walls 18b as guiding the terrace 16h in the sides of the optical receptacle 16 by the second inner surface 18d. Setting the optical receptacle 16 between the side walls 18b, the bottom 16i may come in contact with front bottom 18e of the frame 18. Subsequently, a screw 20 is fastened with the screw hole formed by two split holes, which forces the optical receptacle rearward such that the flange, 12c and 14c, may be securely put between the rear surface 16c of the optical receptacle 16 and the front surface of the saddle 18f, and the bottom 16i of the optical receptacle 16 may come in securely contact with the front bottom 18e of the frame 18. Thus, the optical transceiver 10 may be completed. The process to manufacture the other optical transceiver 10A is similar to those for the optical transceiver 10 of the first embodiment.

Although the present invention has been fully described in conjunction with the preferred embodiment thereof with reference to the accompanying drawings, it is to be understood that various changes and modifications may be apparent to those skilled in the art. For example, the bottom 16i of the optical receptacle may be optionally formed in any portions as long as the bottom 16i comes in contact with the front bottom 18e of the frame 18. Similarly, the front bottom 18e may be optionally formed in any portions as long as it comes in contact with the bottom 16i. Such changes and modifications are to be understood as included within the scope of the present invention as defined by the appended claims, unless they depart therefrom.

What is claimed is:

1. An optical transceiver optically coupled with an optical connector that secures an optical fiber therein, comprising:
an optical subassembly that installs a semiconductor optical device to be optically coupled with said optical fiber;
a frame configured to mount said optical subassembly and have a pair of side walls each providing a portion of a screw hole;
an optical receptacle configured to receive said optical connector and have a pair of sides each providing another portion of said screw hole, said optical receptacle being separated from said frame and set between said side walls of said frame; and
a screw fastened in said screw hole,
wherein said screw presses said optical receptacle rearward with respect to said frame to fix said optical subassembly securely between said optical receptacle and said frame.

2. The optical transceiver of claim 1,
wherein said optical subassembly provides a sleeve portion with a cylindrical shape being inserted in an opening in said optical receptacle, and said frame provides a saddle to mount said sleeve portion of said optical subassembly,
wherein said sleeve portion provides a flange put between said optical receptacle and said saddle and forced to abut against said frame.

3. The optical transceiver of claim 1,
wherein said side wall of said frame provides a slope where said first portion of said screw hole is formed and said optical subassembly provides a side with another slope where said second portion of said screw hole,
wherein said slope and said another slope forms a gap expanded by said screw hole.

4. A process to assemble an optical transceiver that provides an optical subassembly, an optical receptacle and a frame, said optical receptacle being separated from said frame, said process comprising steps of:
(a) assembling said optical subassembly with said optical receptacle;
(b) setting said optical receptacle assembled with said optical subassembly between sides walls of said frame so as to come a bottom of said optical receptacle in contact with a bottom of said frame;
(c) fastening a screw in a screw hole so as to push said optical receptacle rearward, wherein said screw hole is constituted of a first portion in said side wall and a second portion in a side of said optical receptacle,
wherein said optical receptacle abuts said optical subassembly against said frame to fix a position of said optical subassembly along a longitudinal direction of said optical transceiver.

5. The process of claim 4,
wherein said optical subassembly provides a sleeve portion with a cylindrical shape and said optical receptacle provides an opening in a rear surface thereof,
wherein said process (a) is carried out by inserting said sleeve portion of said optical subassembly into said opening in said optical receptacle.

6. The process of claim 4,
wherein said first portion of said screw hole is provided in a slope in said side wall of said frame and said second portion of said screw hole is provided in another slope in said side of said optical receptacle, said slope facing said another slope with a gap
wherein said process (c) expands said gap between two slopes by fastening said screw in said screw hole.

7. The process of claim 4,
wherein said first portion of said screw hole provides a first center, and said second portion of said screw hole provides a second center, said first center being forward to said second center when said screw hole is fastened in said screw hole.

8. The process of claim 4,
wherein one of said first portion and said second portion of said screw hole has no threads before said screw is fastened into said screw hole.
